(19) United States
(12) Patent Application Publication
(10) Pub. No.: US 2023/0318122 A1
(43) Pub. Date: Oct. 5, 2023

(54) BATTERY MODULE HAVING DOUBLE-SIDED ADHESIVE TAPE FOR REDUCING TEMPERATURE AND PRESSURE CAUSED BY THERMAL RUNAWAY

(71) Applicant: KOREA HIGHTECH CO., LTD., Incheon (KR)

(72) Inventor: Ji-Heung Jung, Incheon (KR)

(21) Appl. No.: 18/067,865

(22) Filed: Dec. 19, 2022

(30) Foreign Application Priority Data
Mar. 31, 2022 (KR) 10-2022-0040066

(51) Int. Cl. H01M 50/342; H01M 50/218; H01M 50/242; H01M 50/375; C09J 7/25; C09J 7/38; C09J 133/08

(52) U.S. Cl. CPC H01M 50/3425; H01M 50/218; H01M 50/242; H01M 50/375; C09J 7/25; C09J 7/385; C09J 133/08; H01M 2200/20; C09J 2203/33; C09J 2301/124; C09J 2301/304; C09J 2301/302; C09J 2301/41; C09J 2301/408

(57) ABSTRACT

Disclosed is a double-sided adhesive tape (30) that is disposed between an outer surface of a mono frame (12) of a battery module (10) and a mica sheet (17) to maintain a strong adhesive state while exhibiting an effect of blocking heat caused by thermal runaway generated from inner battery cells (11) and simultaneously effectively suppressing swelling that causes deformation and explosion. That is, the double-sided adhesive tape (30) is melt and ruptured in a predetermined temperature range to provide a passage through which at least one of a gas and a flame, which are generated and accumulated due to thermal runaway, is discharged to the outside in cooperation with a tear-off hole forming part (A) of the mica sheet (17), which is ruptured when the thermal runaway occurs, thereby effectively suppressing increase of an inner pressure and an inner temperature of the battery module (10). The double-sided adhesive tape (30) includes a laminated structure in which a first adhesive layer (31) having a composition in which a photocuring agent is added to an acrylic-based polymer, a flexible base layer (35) having a composition in which black carbon is added to a polyurethane resin, and a second adhesive layer (32) having a composition in which a photocuring agent is added to an acrylic-based polymer are sequentially laminated.

### CROSS-REFERENCE TO RELATED APPLICATIONS

This U.S. non-provisional patent application claims priority under 35 U.S.C. § 119 of Korean Patent Application No. 10-2022-0040066, filed on Mar. 31, 2022, the entire contents of which are hereby incorporated by reference.

### BACKGROUND

The present invention herein relates to a battery module having a double-sided adhesive tape for reducing a temperature and a pressure in a battery caused by thermal runaway.

In general, a secondary battery comprises a plurality of battery cells each including an electrode assembly in which a positive electrode, a negative electrode, a separator, and an electrolyte are accommodated in a multi-layered case.

FIG. 1A is a schematic structural view of a normally used general battery module including the plurality of battery cells, and FIG. 1B is a schematic cross-sectional view of the battery module in a state in which a mica sheet, as a heat-resistant layer, is attached to an outer surface of an external case (a mono frame) of the battery module illustrated in FIG. 1A.

As illustrated in FIG. 1A, a general battery module 10 includes a plurality of battery cells 11 each including an electrode assembly, and the plurality of battery cells 11 are electrically connected to each other and electrically connected to the outside through an electrode terminal 16. In general, the plurality of battery cells 11 are accommodated in a mono frame 12 that is an external case made of aluminum (Al).

Also, in case when the battery module (10) is being operated, the electrode assemblies in the battery cells 11 generate heat while charging and discharging processes are repeated through the electrode terminal 16, and the generated heat degrades a performance of the battery cells 11. Particularly, thermal runaway may occur with a temperature of about 600° C. to about 900° C. under a condition such as explosion of a portion of the battery cells 11 caused by an external impact, stopped operations of a portion of the battery cells 11, overcharge or overdischarge, or neglect at high temperature of the battery cells 11. The thermal runaway leads to the explosion of the battery cells 11 and the collapse and disassembly in each of the electrode assemblies therein to produce a gas mixture, which significantly increases in vapor pressure and forms a stronger explosive air mixture when discharged to the atmosphere and again the air mixture flows backward to react with other surrounding battery cells 11 to cause chain explosion.

In order to prevent such a thermal runaway phenomenon as above, proposed is a technique of forming a kind of heat-resistant layer by attaching e.g., a mica sheet 17, as a kind of incombustible material, to at least a portion of an outer surface of the mono frame 12 of the battery module 10, as schematically illustrated in FIG. 1B.

In general, the mica sheet 17 is made of a single layer or a laminated structure of a plurality of layers, in which layer mica power is dispersed in a binder. Particularly, a tear-off hole forming part (dashed line portion “A” of FIG. 1B) is formed to be detachable to a predetermined section of the mica sheet 17. The tear-off hole forming part A is designed to be separated from the mica sheet 17 when a vapor pressure generated by the thermal runaway reaches a predetermined pressure, so that a gas and a flame being generated inside of the battery module 10 may be discharged to the outside of the battery module 10 through the tear-off hole forming part to prevent an inner pressure of the battery module 10 from increasing.

However, since the above-described mica sheet 17 has the laminated structure that may provide a passage through which humidity and oily and watery particles of a vapor in the battery cell 11 generated at a high pressure when the thermal runaway occurs therein are easily permeated, the mica sheet 17 is easily damaged by such permeation not to sufficiently function as the heat-resistant layer. In addition, an electrical insulation property of the mica sheet 17 is rapidly deteriorated. Due to recent rapid increase of explosion fire accidents caused by the thermal runaway, technologies for supplementing or improving the above-described structure is urgently demanded.

### PRIOR ART DOCUMENT

### Patent Document

(Patent document 1) Korean Patent Laid-Open Publication No. 10-2021-0088170 (published on 14 Jul. 2021)

(Patent document 2) Korean Patent Registration No. 10-1518189 (published on 6 May 2015)

### SUMMARY

The present invention provides a battery module having a double-sided adhesive tape for simultaneously reducing an inner temperature and an inner pressure caused by thermal runaway occurred from battery cells in a battery module.

An embodiment of the present invention provides a battery module comprising: a plurality of battery cells; a mono frame configured to accommodate the plurality of battery cells therein; and a mica sheet attached to a surface of the mono frame and having a detachable tear-off hole forming part that is to be ruptured at the time when a vapor pressure generated and accumulated by thermal runaway from the battery cells exceeds a predetermined value to provide a passage to the outside of the battery module. Particularly, the battery module further comprises a double-sided adhesive tape disposed and attached between the mono frame and the mica sheet. The double-sided adhesive tape comprises a laminated structure in which a first adhesive layer having a composition in which a photocuring agent is added to an acrylic-based polymer, a flexible base layer having a composition in which black carbon is added to a polyurethane resin, and a second adhesive layer having a composition in which a photocuring agent is added to an acrylic-based polymer are sequentially laminated. Thus, the double-sided adhesive tape is melt and ruptured at a predetermined temperature when the thermal runaway occurs, so that through the passage formed by the ruptured tear-off hole forming part of the mica sheet, at least one of a gas and a flame inside of the battery module being generated by the thermal runaway is discharged to the outside through the passage, thereby suppressing increase of an inner pressure and an inner temperature of the battery module.

In an embodiment, the predetermined temperature may have a maximum of 200° C., and the flexible base layer may have a melting point equal to or lower than 200° C.

In an embodiment, the predetermined temperature may have a maximum of 160° C., and the flexible base layer may have a melting point equal to or lower than 160° C.

In an embodiment, an added amount of the black carbon may be in a range from 5 wt % to 20 wt % based on a total amount of the flexible base layer.

In an embodiment, the flexible base layer may have at least one of a tensile strength of 33 Mpa/mm² or less according to ASTM D882 standard and an elongation ratio in a range from 200% to 600% according to the ASTM D882 standard.

In an embodiment, each of the first adhesive layer and the second adhesive layer may have an adhesive force in a range from 600 g·f/25 mm to 3000 g·f/25 mm according to ASTM D3330 standard.

In an embodiment, each of the first adhesive layer and the second adhesive layer may be a pressure sensitive adhesive.

In an embodiment, an added amount of the photocuring agent may be in a range from 1 wt % to 7 wt % based on a total amount of each of the first adhesive layer and the second adhesive layer.

In an embodiment, the photocuring agent may include at least one of an isocyanate-based photocuring agent, a polyamine-based photocuring agent, a metal alkylate-based photocuring agent, a melamine-based photocuring agent, and an aziridine-based photocuring agent.

### BRIEF DESCRIPTION OF THE FIGURES

The accompanying drawings are included to provide a further understanding of the inventive concept, and are incorporated in and constitute a part of this specification. The drawings illustrate embodiments of the inventive concept and, together with the description, serve to explain principles of the inventive concept. In the drawings:

FIG. 1A is a schematic structural view of a substantially used general battery module including a plurality of battery cells;

FIG. 1B is a schematic cross-sectional view of the battery module in a state in which a mica sheet that is a heat-resistant layer is attached to an outer surface of an external case (a mono frame) of the battery module illustrated in FIG. 1A;

FIG. 2A is a schematic structural view of a double-sided adhesive tape 30 according to the present invention;

FIG. 2B is a schematic structural view illustrating a state in which the double-sided adhesive tape 30 according to the present invention is attached to the outer surface of the mono frame 12 of the general battery module illustrated in FIGS. 1A and 1B;

FIG. 3 is a view for explaining an evaluation of an adhesive force test of a first adhesive layer 31 and a second adhesive layer 32 in the double-sided adhesive tape 30 of the present invention according to ASTM D3330 standard;

FIG. 4 is a view for explaining an evaluation of a tensile strength test of the flexible base layer 35 in the double-sided adhesive tape 30 of the present invention maintain according to ASTM D882 standard; and

FIGS. 5A to 5D are photographs for explaining an evaluation of a melting point test of the flexible base layer 35 in the double-sided adhesive tape 30 of the present invention, FIG. 5A shows a sample tape preparation process, FIG. 5B shows a process in which the sample tape of FIG. 5A is left at a temperature of 160° C., FIG. 5C shows a result state of FIG. 5A, and FIG. 5D shows a result state when the sample tape of FIG. 5A is left at a temperature of 170° C. or more.

### DETAILED DESCRIPTION

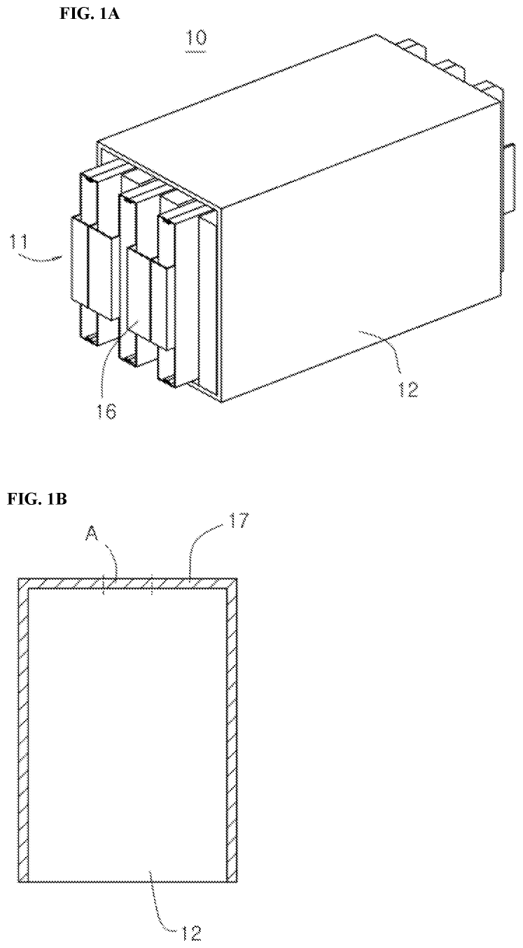

The present invention provides a battery module 10 having a double-sided adhesive tape, which provides a passage through which a gas and a flame in the battery module 10 is discharged to the outside together with a tear-off hole forming part (dashed line portion “A” of FIG. 1B) which is detachably used with a mica sheet for preventing thermal runaway of a typical battery module, thereby relieving increase of an inner temperature and an inner pressure of the battery module 10. As such, the double-sided adhesive tape according to the present invention may prevent heat and swelling that may cause deformation or explosion due to rapid expansion of a volume of the battery module and/or battery cells disposed therein caused by occurrence of the thermal runaway.

Hereinafter, the present invention will be described in detail with reference to the accompanying drawings.

Firstly, referring to FIGS. 1A and 1B, a whole or at least a portion of the double-sided adhesive tape according to the present invention may be disposed between the mica sheet 17 and an outer surface of the mono frame 12 of the battery module 10.

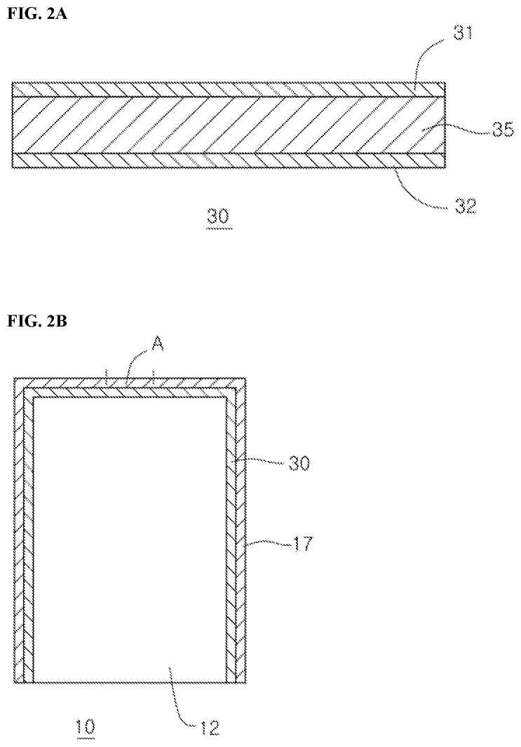

And, the double-sided adhesive tape of the battery module 10 according to the present invention will be described in more detail with reference to FIGS. 2A and 2B. FIG. 2A is a schematic structural view of a double-sided adhesive tape 30 according to the present invention, and FIG. 2B is a schematic structural view illustrating a state in which the double-sided adhesive tape 30 according to the present invention is attached to the outer surface of the mono frame 12 of the general battery module illustrated in FIGS. 1A and 1B.

As illustrated in FIG. 2A, the double-sided adhesive tape 30 according to the present invention is configured such that a first adhesive layer 31, a flexible base layer 35, and a second adhesive layer 32 are sequentially laminated. In an embodiment of the present invention, the double-sided adhesive tape 30 may have a maximum thickness of about 0.3 mm, but the present invention is not limited thereto.

Also in the present invention, similarly to the conventional art as described above, a tear-off hole forming part (dashed line portion “A” of FIG. 2B) is formed in a predetermined region of the mica sheet 17 in a detachable manner. The tear-off hole forming part gets separated from the mica sheet due to a high vapor pressure (e.g., 1 kg or more) being generated at the time of the thermal runaway, so that a gas and a flame generated inside of the battery module 10 may be discharged to the outside of the battery module 10 through the tear-off hole forming part A, thereby preventing an inner pressure of the battery module 10 from increasing.

Here, preferably, the double-sided adhesive tape 30 according to the present invention is designed to cooperate with the mica sheet 17 which has the tear-off hole forming part A. That is, a base material of the double-sided adhesive tape 30 according to the present invention is designed to be melt and ruptured at a predetermined relatively low surrounding temperature, so that the double-sided adhesive tape 30 may cooperate with the tear-off hole forming part A which gets separated from the mica sheet 17 at a high vapor pressure to provide a passage through which a gas and a flame inside of the battery module 10 may be discharged. As such, the increase of the inner pressure and the inner temperature inside the battery module 10 may be suppressed.

In an embodiment of the present invention, a composition base material of the flexible base layer 35 that occupies a main volume of the double-sided adhesive tape 30 may have a melting point that is about 200° C. or lower, preferably about 180° C. or lower, more preferably about 170° C. or lower, and most preferably about 160° C. or lower, but the present invention is not limited thereto and the melting point may be designed to optionally increase or decrease, depending on a composition and a content of each composition base material of the first adhesive layer 31, the flexible base layer 35, and the second adhesive layer 32, and particularly depending on a composition and a content of the composition base material of the flexible base layer 35.

Hereinafter, each of the layers of the double-sided adhesive tape 30 according to the present invention will be described in detail with reference to FIGS. 2A and 2B.

### First Adhesive Layer 31 and Second Adhesive Layer 32

Referring to FIGS. 2A and 2B, in an embodiment of the present invention, a whole or at least a portion of the double-sided adhesive tape 30 may be disposed between the mica sheet 17 and an outer surface of the mono frame 12 of the battery module 10. That is, for an example, the first adhesive layer 31 may be attached onto a surface of the metallic mono frame 12 of the battery module 10, while the second adhesive layer 32 may be attached onto a bottom surface of the mica sheet 17. In this case, the first adhesive layer 31 may be preferably made of a material that is attachable to a metal surface such as injected aluminum, aluminum anodizing, electro galvanized iron (EGI), and galvanium.

Also, in the present invention, each of the first adhesive layer 31 and the second adhesive layer 32 may be preferably made of a pressure sensitive adhesive (PSA).

Also, in an embodiment of the present invention, the first adhesive layer 31 being attached onto the surface of the mono frame 12 of the battery module 10 may have a thickness in a range from about 0.01 mm to about 0.1 mm, and the second adhesive layer 32 attached onto the surface of the mica sheet 17 may have a thickness in a range from about 0.02 mm to about 0.08 mm.

Also, in an embodiment of the present invention, each of the first adhesive layer 31 and the second adhesive layer 32 may have an adhesive force in a range from about 600 gf/25 mm to about 3000 gf/25 mm according to ASTM D3330.

Also, in an embodiment of the present invention, each of the first adhesive layer 31 and the second adhesive layer 32 may have an acrylic polymer as a base composition, and such an acrylic polymer may be an adhesive composition comprising at least one selected from the group consisting of a (metha) acrylic monomer, an oligomer, a resin, and a combination thereof, but the present invention is not limited thereto and for example may use any sort of well-known acrylic polymers.

Also, in the present invention, each composition of the first adhesive layer 31 and the second adhesive layer 32 may further include a photocuring agent. In an embodiment, a content of the photocuring agent may be about 1 wt % to about 7 wt % based on a total amount of each composition of the first adhesive layer 31 and the second adhesive layer 32. Also, as the photocuring agent, at least one of an isocyanate-based, a polyamine-based, a metal alkylate-based, a melamine-based, and an aziridine-based compositions may be used.

### Flexible Base Layer 35

According to the present invention, the flexible base layer 35 has a composition in which black carbon is added to a polyurethane resin to increase a tensile strength thereof. In an embodiment of the present invention, preferably the polyurethane resin may be a thermoplastic polyurethane (TPU) that is easily processed in extrusion molding, vacuum molding, thermal bonding, and a high frequency process. Also, in an embodiment of the present invention, the black carbon may be added in a content of about 5 wt % to about 20 wt % based on the total amount of the flexible base layer 35. Here, in case when the content of the black carbon exceeds the maximum content, a space ratio between particles of the black carbon in the flexible base layer 35 may increase, which may rather weaken the tensile strength.

Also, in an embodiment of the present invention, the flexible base layer 35 may have an elongation ratio in a range from about 200% to about 600%. Also, in an embodiment of the present invention, the tensile strength of the flexible base layer 35 may be equal to or less than about 33 Mpa/mm² according to ASTM D882, which is optimal for commercialization of the battery module 10.

Also, in an embodiment of the present invention, as described above, the composition base material of the flexible base layer 35 may have a melting point of about 200° C. or lower, preferably about 180° C. or lower, more preferably 170° C. or lower, and most preferably about 160° C. or lower, but the present invention is not limited thereto.

### Evaluation of Adhesive Force of First Adhesive Layer 31 and Second Adhesive Layer 32

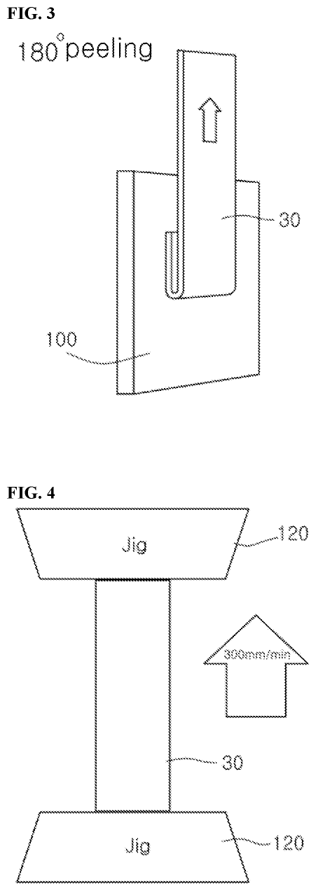

As an embodiment of the present invention, a method for evaluating an adhesive force of each of a first adhesive layer 31 and a second adhesive layer 32 will be described with reference to FIG. 3. FIG. 3 is a view for explaining a test evaluation of an adhesive force of the first adhesive layer 31 and the second adhesive layer 32 in a double-sided adhesive tape 30 of the present invention according to the ASTM D3330 standard.

As shown in FIG. 3, firstly, as a sample tape the double-sided adhesive tape 30 of the present invention is attached onto a steel plate 100 made of stainless 304 with surface roughness equivalent to sandpaper #400, and then the sample tape is compressed by one time reciprocating movement of a roller having a weight of about 2000±50 g at a speed of about 300±20 mm/min and left at room temperature for 30 minutes.

Thereafter, an adhesive force at the time when an end of the sample tape is bent back by 180° and pulled at a speed of about 300±20 mm/min is measured. Here, a 90° peeling method is used when the sample tape has a thickness of 0.45 mm or more, and a 180° peeling method is used when the sample tape has a thickness less than 0.45 mm.

Results of testing and evaluating the adhesive force of the first adhesive layer 31 and the second adhesive layer 32 in the double-sided adhesive tape 30 of the present invention according to the ASTM D3330 standard are summarized in table 1 below.

TABLE 1

| | Evaluated adhesive force of sample | | | Mean |
|---|---|---|---|---|
| Measured portion | tape (g · f/25 mm) | | | adhesive |
| (based on | Embod- | Embod- | Embod- | force |
| ASTM D3330 | iment | iment | iment | (g · f/25 |
| standard) | 1 | 2 | 3 | mm) |
| First adhesive layer 31 | 1645 | 1685 | 1574 | 1634 |
| (attached to mono frame | | | | |
| 12 made of aluminum) | | | | |
| Second adhesive layer | 1832 | 1739 | 1623 | 1731 |
| 32 | | | | |
| (attached to mica sheet | | | | |
| 17 | | | | |

Referring to table 1 as above, it may be understood that at the present adhesive force test, all of the first adhesive layer 31 attached to a surface of the aluminum (Al) mono frame 12 and the second adhesive layer 32 attached to a surface of the mica sheet 17 in the double-sided adhesive tape 30 of the present invention maintain an excellent adhesive state according to the ASTM D3330 standard.

### Evaluation of Tensile Strength of Flexible Base Layer 35

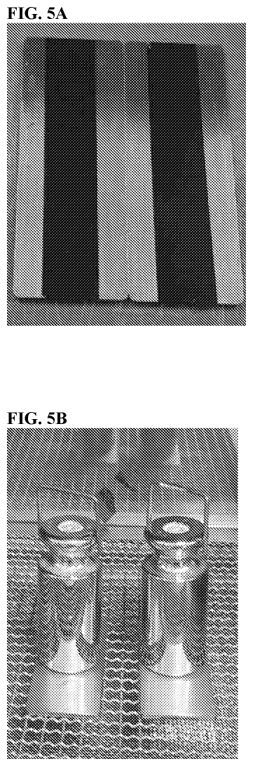

As an embodiment of the present invention, a method for evaluating a tensile strength of the flexible base layer 35 is described with reference to FIG. 4. FIG. 4 is a view for explaining an evaluation of a tensile strength test of the flexible base layer 35 in the double-sided adhesive tape 30 of the present invention according to ASTM D882 standard.

As shown in FIG. 4, the double-sided adhesive tape 30 of the present invention is prepared as a sample tape having a size of 25 mm×50 mm and pulled by a pair of jigs 120 at both sides at a speed of 300 mm/min, and a maximum load and a length of the sample tape being measured using a tensile strength tester at the time when the sample tape is ruptured are measured.

Results of testing and evaluating the tensile strength of the flexible base layer 35 in the double-sided adhesive tape 30 of the present invention according to the ASTM D882 standard are summarized in table 2 below.

TABLE 2

| | | Sample tape | | | |
|---|---|---|---|---|---|
| | | Embod- | Embod- | Embod- | |
| | | iment | iment | iment | Mean |
| Measured portion | | 1 | 2 | 3 | value |
| Flexible | Elongation | 462.9 | 454.12 | 465.78 | 460.93 |
| base layer | ratio (%) | | | | |
| 35 | Tensile | 29.8 | 29.7 | 28.6 | 29.3 |
| | strength | | | | |
| | (MPa) | | | | |

Referring to table 2 above, it may be understood through the evaluation of the tensile strength that the flexible base layer 35 in the double-sided adhesive tape 30 of the present invention maintains an extremely excellent tensile strength value according to the ASTM D882 standard.

### Evaluation of Melting Point of Flexible Base Layer 35

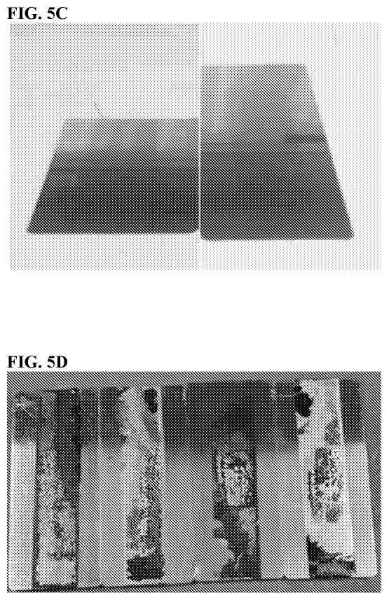

As an embodiment of the present invention, a method for evaluating a melting point of the flexible base layer 35 is described with reference to FIGS. 5A to 5D. This method tests whether the double-sided adhesive tape 30 of the present invention is melt and ruptured under an intended temperature condition in case when the double-sided adhesive tape 30 is attached to a typical battery module 10 for commercialization for an actual use. As described above, in cooperation with the mica sheet 17 that provides the passage as the tear-off hole forming part gets separated due to a high vapor pressure caused by thermal runaway, the rupturing mechanism of the double-sided adhesive tape 30 caused by melting at a designed temperature provides a passage through which passage a gas and a flame in the battery module 10 may be discharged to the outside.

FIGS. 5A to 5D are photographs for explaining an evaluation of a melting point test of the flexible base layer 35 in the double-sided adhesive tape 30 of the present invention. FIG. 5A shows a sample tape preparation process, FIG. 5B shows a process in which the sample tape of FIG. 5A is left at a temperature of 160° C., FIG. 5C shows a result state of FIG. 5A, and FIG. 5D shows a result state when the sample tape of FIG. 5A is left at a temperature of 170° C. or more.

As shown in FIG. 5A, the double-sided adhesive tape 30 of the present invention is prepared as a sample tape having a predetermined size (a size of about 25 mm×100 mm in an embodiment) and cleaned (one time with MEK in an embodiment), attached by one time reciprocating movement of a roller having a weight of about 2 kg according to KS T 1028 standard, and then left at room temperature for 30 minutes (FIG. 5A). Thereafter, a predetermined substrate (a substrate made of a SUS material in an embodiment) is loaded on the attached sample tape, a weight having a predetermined weight (1 kg in an embodiment) is loaded on the substrate at a temperature of 160° C., and a state after being left for a predetermined time (about 24 hours in an embodiment) is observed (FIG. 5C).

As a result of the above melting point evaluation test, it is seen that all of the double-sided adhesive tapes 30 of the present invention maintain a satisfactory state without variation as shown in FIG. 5C, and they become effectively melt and ruptured when a test temperature is raised to equal to or greater than 170° C. as shown in FIG. 5D.

As described above, the double-sided adhesive tapes 30 of the battery module 10 of the present invention include the first and second adhesive layers 31 and 32, which maintain a satisfactory adhesive force, and the flexible base layer 35, which has a tensile strength improved by addition of the black carbon to the polyurethane resin.

Also, one or more double-sided adhesive tapes 30 of the present invention may be disposed between the outer surface of the mono frame 12 of the battery module 10 and the mica sheet 17 to maintain a strong adhesive state, while relieving the increase of the inner temperature and the inner pressure by means of discharging the inner gas and flame from the inner battery cells 11 to the outside at the time when the thermal runaway occurs to effectively suppress the swelling that may cause deformation and explosion.

Particularly, the double-sided adhesive tapes 30 of the present invention provides a passage in cooperation with the tear-off hole forming part of the mica sheet 17 at the time when the thermal runaway occurs, through which at least one of the gas and the flame which are generated and accumulated by the thermal runaway may be discharged to the outside, thereby significantly relieving the inner temperature and the inner pressure of the battery module 10.

Although the embodiments of the present invention have been described, it is understood that the present invention should not be limited to these embodiments but various changes and modifications can be made by one ordinary skilled in the art within the spirit and scope of the present invention as hereinafter claimed.

What is claimed is:

1. A battery module (10) comprising:
a plurality of battery cells (11);
a mono frame (12) configured to accommodate the plurality of battery cells (11) therein; and
a mica sheet (17) attached to a surface of the mono frame (12) and having a detachable tear-off hole forming part (A) that is to be ruptured at the time when a vapor pressure generated and accumulated by thermal runaway from the battery cells (11) exceeds a predetermined value to form a passage to the outside of the battery module (10),
wherein the battery module (10) further comprises a double-sided adhesive tape (30) disposed and attached between the mono frame (12) and the mica sheet (17), the double-sided adhesive tape (30) comprising a laminated structure in which a first adhesive layer (31) having a composition in which a photocuring agent is added to an acrylic-based polymer, a flexible base layer (35) having a composition in which black carbon is added to a polyurethane resin, and a second adhesive layer (32) having a composition in which a photocuring agent is added to an acrylic-based polymer are sequentially laminated, and
wherein the double-sided adhesive tape (30) is melt and ruptured when the thermal runaway occurs, so that through the passage being formed in cooperation with the ruptured double-sided adhesive tape (30) and the ruptured tear-off hole forming part (A) of the mica sheet (17), at least one of a gas and a flame inside of the battery module (10) being generated by the thermal runaway is discharged to the outside, thereby suppressing increase of an inner pressure and an inner temperature of the battery module (10).

2. The battery module of claim 1, wherein the predetermined temperature has a maximum of 200° C., and the flexible base layer (35) has a melting point equal to or less than 200° C.

3. The battery module of claim 1, wherein the predetermined temperature has a maximum of 160° C., and the flexible base layer (35) has a melting point equal to or less than 160° C.

4. The battery module of claim 1, wherein an added amount of the black carbon is in a range from 5 wt % to 20 wt % based on a total amount of the flexible base layer (35).

5. The battery module of claim 1, wherein the flexible base layer (35) has at least one of a tensile strength of 33 Mpa/mm² or less according to ASTM D882 standard and an elongation ratio in a range from 200% to 600% according to the ASTM D882 standard.

6. The battery module of claim 1, wherein each of the first adhesive layer (31) and the second adhesive layer (32) has an adhesive force in a range from 600 g·f/25 mm to 3000 g·f/25 mm according to ASTM D3330 standard.

7. The battery module of claim 1, wherein each of the first adhesive layer (31) and the second adhesive layer (32) is a pressure sensitive adhesive.

8. The battery module of claim 1, wherein an added amount of the photocuring agent is in a range from 1 wt % to 7 wt % based on a total amount of each of the first adhesive layer (31) and the second adhesive layer (32).

9. The battery module of claim 1, wherein the photocuring agent comprises at least one of an isocyanate-based photocuring agent, a polyamine-based photocuring agent, a metal alkylate-based photocuring agent, a melamine-based photocuring agent, and an aziridine-based photocuring agent.
